(19) United States
(12) Patent Application Publication
(10) Pub. No.: US 2025/0381546 A1
(43) Pub. Date: Dec. 18, 2025

(54) CHEMICAL CONVERSION DEVICE

(71) Applicant: ATMOSPHERIC PLASMA SOLUTIONS, INC., Cary, NC (US)

(72) Inventor: Peter Yancey, Sanford, NC (US)

(21) Appl. No.: 18/877,189

(22) PCT Filed: Jun. 21, 2023
(86) PCT No.: PCT/IB2023/056435

§ 371 Date: Dec. 19, 2024

Related U.S. Application Data
(60) Provisional application No. 63/353,943, filed on Jun. 21, 2022.

(51) Int. Cl. B01J 19/08; C01B 21/38; C05C 5/00; C05G 5/23

(52) U.S. Cl. CPC B01J 19/088; C01B 21/38; C05C 5/00; C05G 5/23; B01J 2219/0877; B01J 2219/0896

(57) ABSTRACT

The present disclosure provides systems and methods for effecting chemical conversion using a plasma generating device. Advantageously, the plasma generating device is configured to directly deliver a plasma to fluid within a reservoir in a manner sufficient to create supersonic flow within the fluid. Such systems and methods can enhance reaction efficiency and convenience. A method of providing a point-of-use fertilizer composition is disclosed; the method comprising: introducing a gas feed stream comprising air into a plasma generating device; operating the plasma generating device to produce a plasma output comprising NOx compounds; injecting the plasma output through an outlet component into a reservoir having a fluid contained therein in a manner sufficient to create 5 supersonic flow within the fluid, wherein the outlet component is submerged within the fluid and wherein the fluid comprises water; withdrawing a liquid product stream from the reservoir; and optionally adjusting the pH of the liquid product stream for use as a point-of-use fertilizer composition.

### FIELD OF THE DISCLOSURE

The present disclosure relates to a system for effecting various chemical reactions and for methods involving use of such systems.

### BACKGROUND

Nitrate-based fertilizers are important in agriculture, serving to enhance plant growth and provide a ready supply of nitrogen, an important macronutrient for plants. One of the first industrial processes for nitrate-based fertilizer production was the Birkeland-Eyde process disclosed, e.g., in U.S. Pat. No. 772,862. This process is a multi-step nitrogen fixation process involving passing air through an electric arc (thermal plasma), thereby producing nitric oxide and nitrogen dioxide; the nitrogen dioxide could then be concentrated and introduced into water to form nitric acid. This nitric acid (HNO₃) was neutralized with ammonia to form ammonium nitrate. However, the Birkeland-Eyde process utilized low efficiency electrical generation and transformers that were lossy and operated at low frequencies (<60 Hertz). The chemical efficiency of the Birkeland-Eyde process was also lower than that of the Haber-Bosch process and is considered obsolete today.

Today, nitrate-based fertilizers are typically made through the energy and fossil fuel resource-intensive Haber Bosch process (converting atmospheric nitrogen and hydrogen sourced from natural gas to ammonia), followed by the Ostwalt process (oxidizing the ammonia to form nitric oxide and nitrogen dioxide). As in the Birkeland-Eyde process, the nitrogen dioxide is then concentrated and introduced into water to form nitric acid, which can be neutralized with ammonia to form ammonium nitrate. The Haber-Bosch process, although it accounts for the majority of nitrogen-based fertilizer production, is highly inefficient, consuming a significant amount of fossil fuel-derived natural gas and large amounts of energy (as it operates at high temperatures and high pressures). Furthermore, this process results in the production of undesirable CO₂ emissions.

It would be desirable to provide further systems and methods for the production of nitrate-based fertilizers, among other chemical species.

### BRIEF SUMMARY

The present disclosure relates to chemical conversion of various species based at least in part, on plasma generation and direct injection of the plasma into a fluid. The disclosed systems and methods allow for the use of various input materials, which are converted to a plasma state within a plasma generation device/plasma source. The chemical species generated within the plasma are controlled, at least in part, by the composition of the input reactants and can be tuned accordingly to obtain the desired plasma-generated species, which can act as reagents for further reaction. Advantageously, according to the disclosed systems and methods, the plasma is directly introduced into a fluid such that a high energy zone is created within the fluid. This high energy zone can result in the formation of desired product and/or induce secondary reactions to produce further desired product within the fluid. The principles outlined herein are broadly applicable for the production of a wide range of products and the features of the system are readily modified to impact the chemical reaction(s), as will be described further herein.

In some embodiments, the disclosed systems and methods can afford a unique means for producing chemical compounds that would otherwise require industrial-scale chemical facilities (e.g., involving complex, high-power, high-temperature, and/or high-pressure chemical reactors) or other exotic methods, such as explosive-induced reactions. The systems and methods can, in some embodiments, employ high efficiency power generation and power conversion technologies to produce sufficient voltages and currents required to drive the plasma source. Further, in some embodiments, the disclosed systems and methods can employ chemical feedstocks that are lower in cost and/or pose less potential concern for environmental harm than such industrial methods.

The present disclosure includes, without limitation, the following embodiments:

Embodiment 1: A system for effecting a chemical conversion, comprising: a plasma generating device comprising a gas input for a gas feed stream and configured for the production of a plasma output; a reservoir having a fluid contained therein, and an outlet component for direct delivery of the plasma output to the fluid in a manner sufficient to create supersonic flow within the fluid, wherein the component for direct delivery of the plasma output to the fluid is submerged within the fluid.

Embodiment 2: The system of Embodiment 1, wherein the outlet component for direct delivery of the plasma output to the fluid is selected from the group consisting of a converging/diverging nozzle and an orifice plate.

Embodiment 3: The system of Embodiment 1 or 2, wherein the plasma generating device is submerged within the fluid and, in particular, wherein the outlet component is submerged within the fluid.

Embodiment 4: The system of any of Embodiments 1-3, wherein the plasma generating device is selected from a high frequency plasma generating device (e.g., induction plasma, capacitive plasma, torch plasma, corona discharge plasma, plasma with high-frequency corona, and microwave plasmas), an arc plasma generating device (e.g., a hollow cathode plasma), a magnetron source plasma generating device, a microwave plasma source, a cathodic arc source, an end hall source, an electron cyclotron source, a varying frequency capacitive source, a varying frequency inductive source, a transformer-type inductive plasmatron source, a dielectric barrier discharge source, and a capillary discharge source.

Embodiment 5: The system of any of Embodiments 1-4, wherein the plasma generating device is a non-thermal plasma source that generates plasma via direct current (DC), alternating current (AC), radiofrequency (Rf) inductively coupled plasma (ICP), microwave, asymmetric unipolar or bipolar waveforms.

Embodiment 6: The system of any of Embodiments 1-5, wherein the plasma generating device comprises one or more glow discharge electrodes, one or more dielectric barrier discharge electrodes, one or more thermally arcing electrodes, and/or one or more gliding arc discharge electrodes.

Embodiment 7: The system of any of Embodiments 1-6, wherein the fluid comprises water.

Embodiment 8: The system of any of Embodiments 1-6, wherein the fluid comprises a non-aqueous liquid.

Embodiment 9: The system of any of Embodiments 1-8, wherein the fluid comprises one or more additives selected from catalysts, reagents, pH adjusters, buffers, and combinations thereof.

Embodiment 10: The system of Embodiment 9, wherein the one or more additives are dissolved in or dispersed in the fluid.

Embodiment 11: The system of Embodiment 9, wherein the one or more additives are in the form of a material contained within a porous container, a material deposited onto a substrate scaffold, or a consumable solid piece of material.

Embodiment 12: The system of any of Embodiments 1-11, wherein the reservoir is open to atmospheric conditions.

Embodiment 13: The system of any of Embodiments 1-11, wherein the reservoir is not open to atmospheric conditions.

Embodiment 14: The system of any of Embodiments 1-13, further comprising a gas outlet to remove gas present or produced within the reservoir.

Embodiment 15: The system of Embodiment 14, further comprising a conduit for directing the gas present or produced within the reservoir back into the plasma generating device or back into the fluid.

Embodiment 16: A method for effecting a chemical conversion, comprising: introducing a gas feed stream into a plasma generating device; operating the plasma generating device to produce a plasma output; and injecting the plasma output through an outlet component into a reservoir having a fluid contained therein in a manner sufficient to create supersonic flow within the fluid, wherein the outlet component is submerged within the fluid.

Embodiment 17: The method of Embodiment 16, wherein the outlet component is selected from the group consisting of a converging/diverging nozzle and an orifice plate.

Embodiment 18: The method of Embodiment 16 or 17, wherein the gas feed stream comprises air.

Embodiment 19: The method of any of Embodiments 16-18, wherein the gas feed stream comprises methane, ethane, phosphane, ammonia, hydrazine, dimethyl hydrazine, hydride gases, hydrogen (H), nitrogen (N), oxygen (O), fluorine (F), chlorine (Cl), helium (He), neon (Ne), argon (Ar), krypton (Kr), Xenon (Xe), or any combination of two or more thereof.

Embodiment 20: The method of any of Embodiments 16-19, wherein the plasma output is a non-thermal plasma.

Embodiment 21: The method of any of Embodiments 16-20, wherein the fluid comprises water.

Embodiment 22: The method of any of Embodiments 16-21, further comprising withdrawing a liquid product stream from the reservoir.

Embodiment 23: The method of any of Embodiments 16-22, further comprising contacting the liquid product stream with one or more catalysts and/or pH adjusters.

Embodiment 24: The method of Embodiment 22 or 23, wherein the gas feed stream comprises air, the fluid comprises water, and the product stream comprises nitric acid.

Embodiment 25: A method of providing a point-of-use fertilizer composition, comprising: introducing a gas feed stream comprising air into a plasma generating device; operating the plasma generating device to produce a plasma output comprising NOₓ compounds; injecting the plasma output through an outlet component into a reservoir having a fluid contained therein in a manner sufficient to create supersonic flow within the fluid, wherein the outlet component is submerged within the fluid and wherein the fluid comprises water; withdrawing a liquid product stream from the reservoir; and optionally adjusting the pH of the liquid product stream for use as a point-of-use fertilizer composition.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended to be combinable, unless the context of the disclosure clearly dictates otherwise.

### BRIEF DESCRIPTION OF THE DRAWINGS

Having thus described the disclosure in the foregoing general terms, reference will now be made to the accompanying drawings, which are not necessarily drawn to scale. The drawings are exemplary only, and should not be construed as limiting the invention.

FIG. 1 is a general schematic depiction of a system according to one embodiment of the present disclosure;

FIG. 2 is a schematic depiction of a system according to one embodiment of the present disclosure;

FIG. 3 is a general schematic depiction of a venturi device employed in one embodiment of the present disclosure;

FIG. 4 is a schematic depiction of a plasma source according to one embodiment of the present disclosure;

FIG. 5 is a flow chart of non-limiting process steps according to one embodiment of the present disclosure;

FIG. 6 is a flow chart of non-limiting process steps according to one embodiment of the present disclosure;

FIG. 7 is a schematic depiction of a non-limiting system setup according to one embodiment of the present disclosure;

FIG. 8 is a schematic depiction of a non-limiting system setup according to one embodiment of the present disclosure;

FIG. 9 is a schematic depiction of a non-limiting system setup according to one embodiment of the present disclosure;

FIG. 10 is a schematic depiction of a non-limiting system setup according to one embodiment of the present disclosure;

FIG. 11 is a schematic depiction of a non-limiting system setup according to one embodiment of the present disclosure;

FIG. 12 is a schematic depiction of a non-limiting system setup according to one embodiment of the present disclosure; and

FIG. 13 is a schematic depiction of a general process of chemical conversion in one embodiment of the present disclosure.

### DETAILED DESCRIPTION

The present disclosure will now be described more fully hereinafter with reference to example implementations thereof. These example implementations are described so that this disclosure will be thorough and complete, and will fully convey the scope of the disclosure to those skilled in the art. Indeed, the disclosure may be embodied in many different forms and should not be construed as limited to the implementations set forth herein; rather, these implementations are provided so that this disclosure will satisfy applicable legal requirements. As used in the specification and the appended claims, the singular forms “a,” “an,” “the” and the like include plural referents unless the context clearly dictates otherwise.

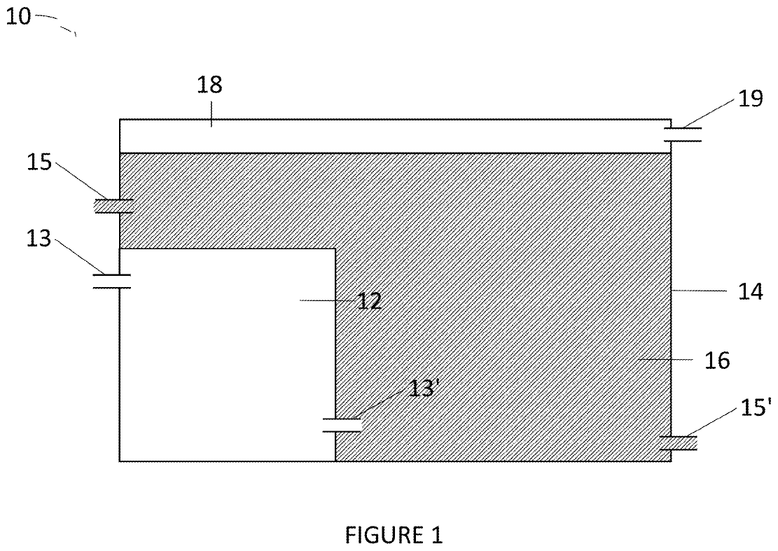

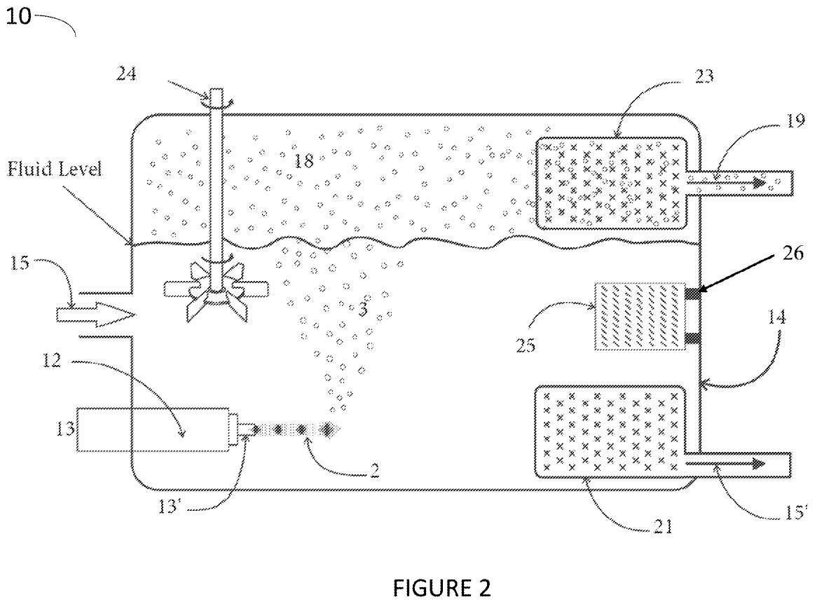

The disclosure provides, in one aspect, a system for chemical reaction/chemical conversion. The system 10 generally comprises a plasma source 12 within a reservoir 14, wherein the reservoir 14 comprises a fluid 16, as schematically depicted in FIG. 1. The plasma source 12 generally includes at least one inlet 13 and at least one outlet 13′, which is in direct fluid contact with fluid 16 such that, during use, chemical species generated by the plasma within plasma source 12 can be introduced directly into fluid 16 within reservoir 14. The system 10 further comprises a reservoir inlet 15 and reservoir outlet 15′, as well as an outlet 19 for release of gas from headspace 18. Each of these components, as well as further optional components that can be included within the system 10 will be described herein below in further detail. It is to be understood that various components described and illustrated in specific embodiments (e.g., FIGS. 2 and 7-12) can individually be employed and all of the components shown within a specific system need not be employed together in all embodiments (e.g., certain components depicted in one system may not be required in that system, and certain components from another depicted system can be incorporated within such system).

Plasma source 12 (also referred to as a plasma generator, a plasma generating device, or a plasma device) is any device capable of producing a plasma. As used herein, the term “plasma” has its conventional meaning as a state of matter distinct from solid, liquid, and gas. Plasma generally refers to a (partially) ionized gas-like mass comprising a mixture of ions, electrons and neutral species. Thermal and non-thermal plasma sources, as well as “warm” plasma sources can be produced and employed by the systems and methods of the present disclosure. As used herein, a “non-thermal plasma” generally refers to a plasma exhibiting low temperature ions (relative to a “thermal” plasma) and high electron temperatures relative to the temperature of the surrounding gas (e.g., such that the electrons are not in equilibrium with the heavier plasma species). A thermal plasma exhibits a higher overall energy density and both high electron temperatures and high ion and neutral temperatures (e.g., such that the electrons and the heavier plasma species are in thermal equilibrium, forming a quasi-neutral plasma bulk). Typically, the temperature of a thermal plasma is high, e.g., on the order of 10⁴ K. Warm plasmas are a designation of plasmas between thermal and non-thermal plasmas, where temperatures are not as high as those of a thermal plasma, but where the electron temperature is still higher than the temperature of the surrounding gas.

The composition of the plasma that can be produced via plasma source 12 is not particularly limited; as will be described further herein below, the plasma produced via plasma source 12 can advantageously, in some embodiments, be tailored to effect certain chemical conversions within the disclosed system. The plasma source 12 thus, in some embodiments, can be configured to produce a plasma comprising one or more specific components. Within the plasma source, molecules are vibrationally excited and, in this excited state, high energy electrons collide with molecules, forming further products (referred to herein as “plasma-generated chemical species”).

Suitable plasma sources for use within system 10 can vary. One of skill in the art will readily appreciate the various types of plasma sources and be able to employ/adapt them for use as the plasma source 12 within the disclosed system. Plasma sources generally require at least one energy input to produce and/or sustain the plasma. In some embodiments, the plasma source may be characterized, e.g., based on the power source used to generate the plasma. In some embodiments, the plasma source 12 comprises a direct current (DC) electric power source, e.g., in which a DC electrical field is applied across a cathode and anode, causing ionization within the plasma source 12 to give DC glow discharge. In some embodiments, the plasma source 12 comprises an alternating current (AC) power source, which produces a plasma by inductively or capacitively coupling energy into the plasma discharge, i.e., capacitively coupled discharge (CCD) or inductively coupled discharge (ICD) at frequencies ranging from 10 s of Hz to 100 s of GHz. In another embodiment, the plasma is excited using a non-symmetric waveform AC waveform that is modulated using feedback from various process monitors to maximize the desired chemical reactions.

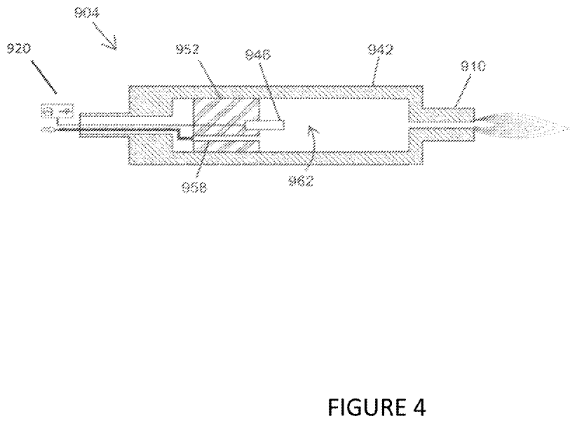

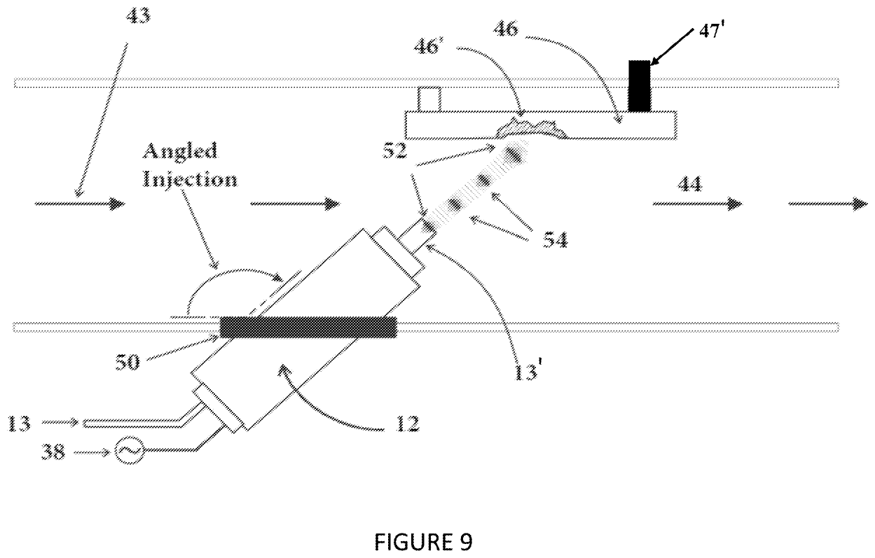

In some embodiments, plasma device 12 is a device as described in U.S. Pat. No. 10,984,984 to Yancey, which is incorporated herein by reference in its entirety. One exemplary plasma device as outlined in the '984 patent comprises a high voltage electrode at which the plasma is ignited; the plasma is contained by a coaxial grounded electrode and a surrounding air curtain supplied by the gas source through the entrance (near 920, FIGS. 9A/9B). See FIG. 4 of the present application (reproduced from FIG. 9B of the '984 patent), wherein the plasma extends the length of the column inside the plasma device 962 and exits the device at 910. Within this device, the plasma is ignited at a high voltage electrode 946 and is contained by a coaxial grounded electrode and a surrounding air curtain supplied by the gas source through the entrance near 920. Referring to FIG. 4, the area inside the plasma device 962 can utilize a vortex flow or reverse vortex flow to stabilize the plasma. The plasma flows out of a nozzle, resulting in shockwaves and supersonic, turbulent flow away from the outlet (e.g., nozzle). It is noted that other plasma device configurations outlined in the '984 patent can alternatively be employed/adapted for use within the systems of the present disclosure.

Plasma device 12, in some embodiments, is selected from a hollow cathode enhanced plasma source, a magnetron source, a micro hollow cathode source, a microwave plasma source, a cathodic arc source, an end hall source, an electron cyclotron source, a varying frequency (AC, HF, RF) capacitive source, a varying frequency (AC, HF, RF) inductive source, a transformer-type inductive plasmatron source, a dielectric barrier discharge source, a capillary discharge source, a thermal plasma source (DC, AC, RF, microwave, asymmetric unipolar or bipolar waveforms), and a non-thermal plasma source (DC, AC, RF, microwave, asymmetric unipolar or bipolar waveforms).

In some embodiments, the plasma device is a transformer-type virtual plasma winding source (which uses the inductive excitation of a magnetic transparent (i.e., quartz) hollow chamber to produce an electrodeless plasma discharge with powers demonstrated to exceed 1 MW). The transformer-type plasma torch represents a transformer, in which the primary winding is fed from the generator at frequencies 1-500 kHz and electrodeless plasma forming in the toroidal chamber forms the secondary turn of the electrical circuit. The transformer-type plasma torches combine the advantages of electrodeless discharge the advantages of the simple power supply (commercially produced high power solid-state direct switching system or transformer generators) by comparison with sources of RF and microwave electrodeless discharges and provide the plasma production in large-volume discharge chambers.

Outlet 13′ is a component of system 10 through which plasma generated within plasma device 12 is removed from the device and brought into contact with fluid 16 within reservoir 14. Outlet 13′ can comprise, for example, a nozzle (e.g., a converging/diverging nozzle) through which the plasma is forced after production. The nozzle expansion geometry may be varied. In some embodiments, outlet 13′ comprises a single nozzle. In some embodiments, outlet 13′ comprises multiple converging/diverging nozzles in series or in parallel; in such embodiment, pre-fluid injection chemistry may be conducted before the final plasma product is injected into the reservoir.

Outlet 13′ can alternatively (or in addition) comprise an orifice plate or any fluidic structure that creates supersonic flow with resulting shockwaves in fluid 16. Generally, in use, plasma passes through outlet 13′ in a manner so as to cause turbulent/shocked flow and so as to result in the formation of shockwaves and cavitation at the boundary between plasma exiting outlet 13′ and the fluid 16 in the reservoir.

Reservoir 14 is not particularly limited and can be any type of container suitable to hold fluid 16. The size and shape may vary and may depend, at least in part, on the size and shape of plasma device 12. Typically, the reservoir is equipped with one or more inlets and/or outlets, e.g., inlet 15 through which the fluid can be added, outlet 15′ through which fluid can be removed (as batches or as a continuous stream), and outlet 19 through which gases can be removed. The system can optionally be equipped with one or more additional inlets and outlets as desired (not shown). Inlets and/or outlets can comprise one or more valves or other components suitable, e.g., for the addition and/or removal of fluids (e.g., gas and/or liquid), catalyst(s), reactant(s), reaction products, etc.) from the reservoir. The reservoir may optionally be connected to one or more additional reservoirs or other units, i.e., the system 10 may, in some embodiments, be a component of a larger system. In certain embodiments, the reservoir may be equipped with a means for providing energy (e.g., microwave or radiofrequency energy) to heat the fluid therein (not shown in FIG. 1). Energy input may further be coupled to specifically engineered conductive structures (e.g., an array of resonant antenna structures) that can optionally be present in or on the reservoir to provide conversion of the energy into an electrical signal. Such electrical signal output can be used to power devices inside the reservoir, initiate and/or add energy to a plasma discharge, or to drive an additional electrochemical process inside the reservoir (e.g., to produce secondary, tertiary, or other desired chemical species).

The composition of the inner and/or outer surfaces of reservoir 14 can vary and can comprise, e.g., glass, metal, ceramic, plastic, or any combination thereof. In some embodiments, reservoir 14 comprises optically or electromagnetically transparent windows. Such optional windows can allow for the introduction of one or multiple wavelengths of light (e.g., to provide additional activation energy to components present within the reservoir to promote/modify reactions occurring therein and/or to provide energy to excite secondary chemical reactions on photocatalytic surfaces within the reservoir).

In some embodiments, reservoir 14 may be open to the atmosphere/unsealed. Such open configurations can be advantageous e.g., if exposure to the ambient atmosphere does not negatively impact the desired chemical reactions/transformations to be conducted within the reservoir. An open reservoir may beneficially allow for the release of heat generated within the reservoir and/or may beneficially allow for the addition of heat into the reservoir from ambient surroundings. Further, in some embodiments, an open reservoir can allow for further reactivity, e.g., involving components present in the local environment of the reservoir.

In some embodiments, reservoir 14 can be closed to the atmosphere/sealed to maintain a particular atmosphere within reservoir 14. In certain embodiments, the reservoir 14 may be situated within a pipe, tube, chamber, or other container that would prevent materials introduced inside the reservoir from interacting with the ambient environment. Therefore, the atmospheric conditions (e.g., gases, temperature, pressure, humidity, etc.) within reservoir 14 can, in some embodiments, be controlled. A closed reservoir can be provided, e.g., by equipping all inputs and outputs associated with the reservoir with gas- and fluid-proof seals. In some embodiments, variable flow valves and/or other pressure- and flow-regulating devices can be used to maintain a specific pressure inside the reservoir.

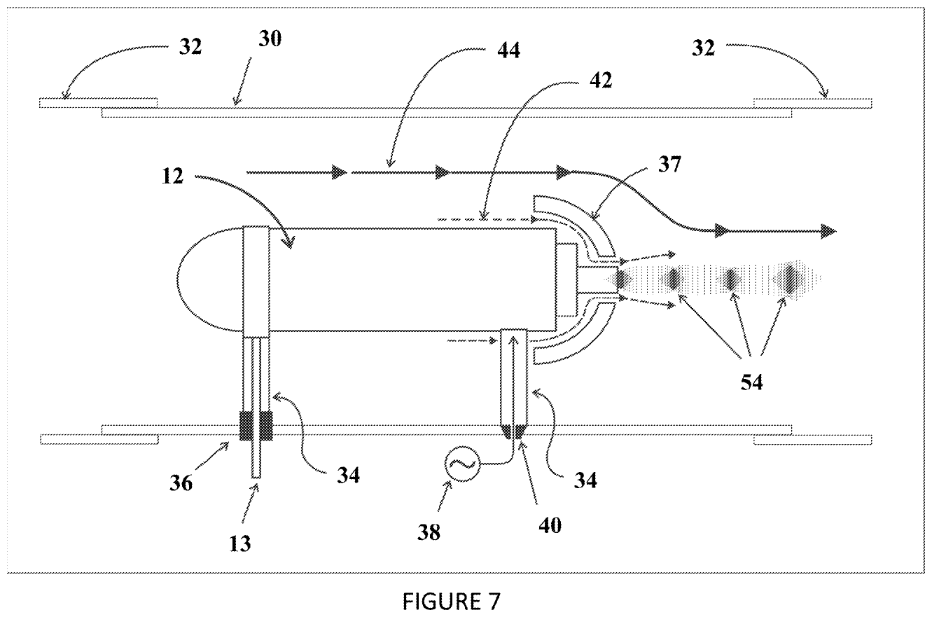

Non-limiting examples of some such enclosed systems are depicted, for example, in FIGS. 7-12. Accordingly, system 10 can be designed so as to allow for aerobic operation and/or anaerobic operation. It is understood that in the systems of FIGS. 7-12, various components depicted in the drawings and shown below are not limited for use within such enclosed systems and may, in some embodiments, be applicable within open systems as well. In some embodiments, as referenced above, certain depicted/described components can be mixed and matched to achieve the desired conversion, i.e., the systems and methods are not to be construed as being strictly limited to the exact combination of components depicted in the figures.

In FIG. 7, plasma device 12 is shown within a pipe. Component 30 is a pipe section, with 32 representing optional flanges, e.g., for in-line coupling. The plasma device 12 is supported via supports 34 (typically shaped to minimize drag, e.g., zero-lift foil sections, such as NACA 0015 foil, although not limited thereto), with gas input passing into the device via inlet 13 associated with the pipe via feed through 36. It is operated via AC/DC input 38 via an electrical feed through 40. The plasma produced within plasma device 12 and ejected through outlet 13′ into the fluid may be subjected to enhanced fluid flow at the boundary between the plasma and the fluid through an optional flow-inducing cowling at 37 and results in rapid directional flow of gas and plasma and shockwaves (54) The dashed arrows 42 depict flow induced by the cowling around the body of the plasma device (“cowling-induced flow”); this induced flow focuses a portion of the fluid through an annular region surrounding output 13′ (e.g., nozzle). This annular region could optionally have a series of flow-directed vanes or surface features to introduce a vortex flow of fluid as it moves through the cowling. This may be used to promote turbulent mixing downstream of the nozzle exit orifice. Cowling could, in some embodiments, induce vortex flow of the liquid at the point where it interacts with the plasma. The arrows labeled 44 represent the fluid flow induced by the injection of gas and plasma.

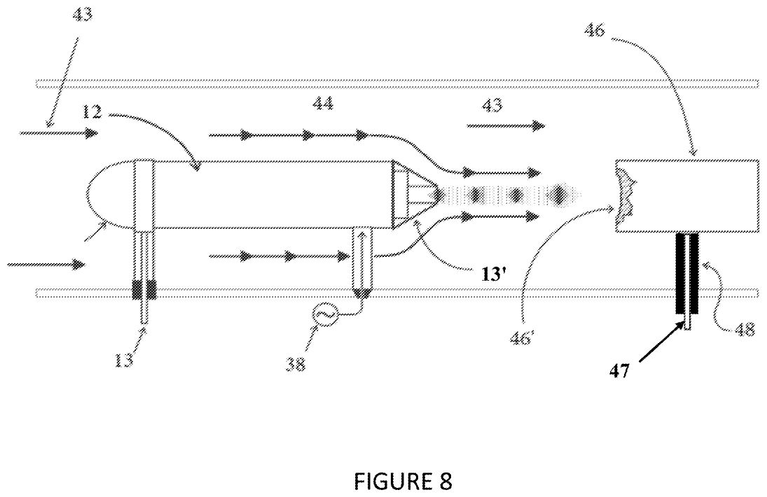

In FIG. 8, plasma device 12 is again within a closed system; in this embodiment, the plasma produced within device 12 is directed to a sacrificial erosion material 46 (supported by support 48), wherein 46′ shows eroded material. The fluid flow is depicted as 43, and the induced fluid flow is depicted as 44. The composition of the sacrificial erosion material 46 can vary. In some embodiments, the sacrificial erosion material is a sacrificial anode, e.g., either by the selection of a galvanically active material or by applying an electrical bias to 46 in order to drive electrochemical etching of the 46 material. Additionally, the pipe or container in FIG. 8 could, in some embodiments, also be electrically biased in order to protect the pipe from accelerated internal corrosion or to utilize the container itself as a source material that is eroded away. Such embodiments are within the scope of the invention (although in FIG. 8, the container serving as source material and the ability to apply a DC or AC bias to it are not explicitly depicted). It is noted that interior structures (like 46, as well as other components described in the application or depicted in the drawings) can, in some embodiments, be electrically isolated from the rest of the chamber. In other embodiments, a conductor (shown as 47) can be used to provide a local electrical ground reference or to place the structure with which it is associated (here, 46) at some electrical potential bias (either AC or DC). This embodiment as shown in FIG. 8 may provide for the control of the erosion rate of 46, e.g., to achieve a desired downstream concentration of a chemical species. As one non-limiting example, where 46 is made of iron, the DC bias on 46 can be increased or decreased to provide more or less iron to be solvated into the solution.

In such embodiments, this can serve as part of a feedback system using sensors to detect relative concentrations of iron or other materials and then change the output bias on structure 46 to achieve a desired concentration setpoint.

FIG. 9 depicts an enclosed system with angled injection. The plasma source 12 is associated with the closed reservoir via a fluid-tight inlet port 50. Plasma source 12 (and injection of the plasma into fluid 16 through outlet 13′) is at an angle relative to fluid flow 43. The angle is not particularly limited. Cavitation 52 and shockwaves 54 are depicted and as in FIG. 8, the system can further comprise a sacrificial erosion material (e.g., plate) 46 (as described above with respect to FIG. 8), shown attached to a closed reservoir wall via a support, where 46 can be isolated or optionally electrically biased via 47, as referenced herein above with respect to the system of FIG. 8.

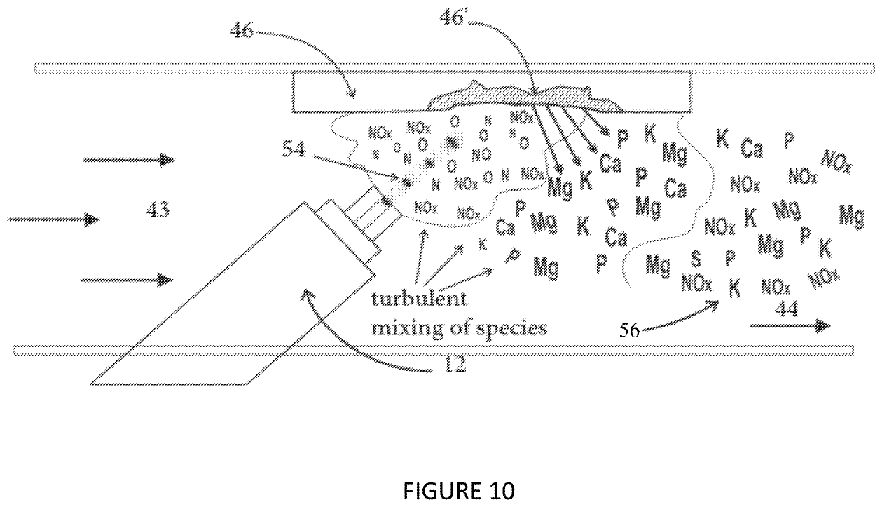

FIG. 10 is an expanded view of certain embodiments encompassed by the present disclosure wherein an erosion material (e.g., plate) is employed. In the depicted example, the erosion material 46 comprises S, Ca, Mg, K, and P. The plasma produced by plasma device 12 is injected into fluid 16, producing shockwaves 54 (with plasma-generated reactive species solvating in the liquid flow shown around shockwave 54) and resulting in cavitation-induced erosion of the plate (shown as 46′). This erosion results in the introduction of eroded elements, molecules, and ions into solution (fluid 16). The turbulent mixing of species within the solution yields, e.g., components 56 within the fluid. In some embodiments, the plate 46 is isolated. Alternatively, in the case of a conductive, semiconductive, or composite plate with interconnected regions of conductive material, the plate 46 could optionally be electrically biased such that the plate is electrochemically eroded in addition to the action of the plasma on the plate. In situations where the reaction chemistry on the surface of the plate creates low conductivity or insulating layers, a pulsed bipolar bias may be employed to drive etching of the insulating material through reverse biasing.

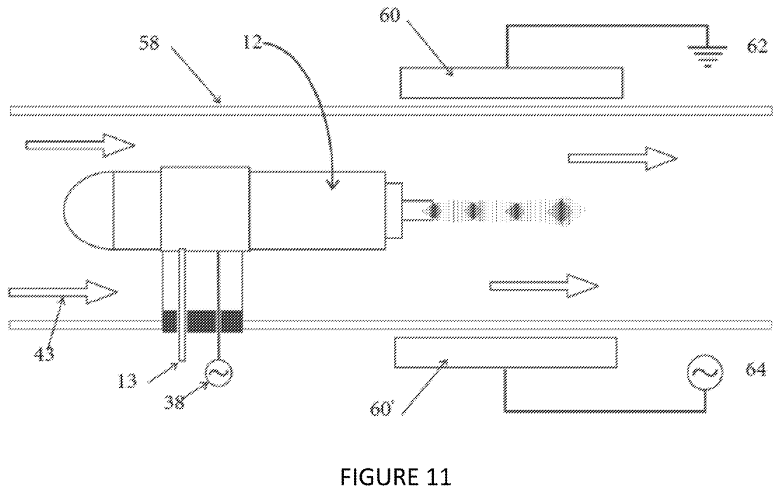

FIG. 11 depicts an embodiment wherein DBD electric field enhancement is employed. Specifically, the plasma device 12 is positioned within a dielectric tube 58; metal electrodes 60 and 60′ positioned on either side (connected to ground 62 and high-voltage AC power source 64). In some embodiments, bubbles downstream of the plasma device 12 exist and could be “reignited” by the intense electric field present in the DBD electrodes. In some embodiments, for example, a coil is present around the chamber. In some embodiments, the plasma could be formed in the bubbles inductively or through an RF or microwave transparent window.

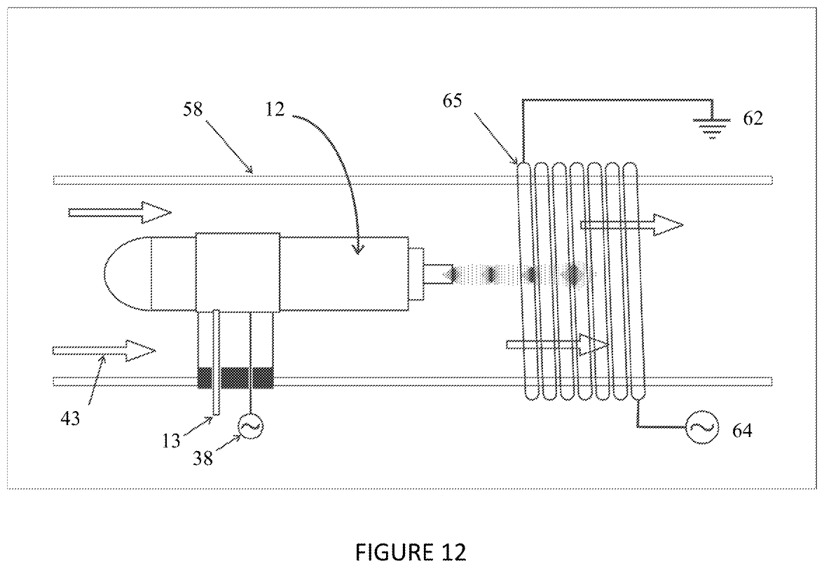

A non-limiting alternative to the embodiment shown in FIG. 11 is shown in FIG. 12, wherein a coil 65 is positioned inside the chamber, in contact with the fluid 16 and co-axial to the outflow of plasma and shockwaves in order to focus the magnetic field into the downstream plasma exiting the nozzle of the plasma device 12. The AC source could be ground referenced, as shown by 62 and 64 or could be driven directly by AC excitation that is not ground referenced. In the latter case, terminal 62 would be replaced with a connection (not shown) to the other leg of the 62 AC generator.

The composition of fluid 16 within the reservoir can vary. Generally, fluid 16 can be in the form of a liquid, gas, supercritical fluid, or mixture of any two or more thereof. In some embodiments, fluid 16 comprises a liquid, consists essentially of a liquid, or consists of a liquid. The composition can depend, for example, on the desired chemical reaction/conversion to be conducted within the system. For example, selection of a suitable fluid 16 can depend on solubilities and/or reactivities of reactants and/or anticipated products. In some embodiments, fluid 16 can comprise water. In some embodiments, fluid 16 is non-aqueous. In some embodiments, fluid 16 comprises a mixture of two or more miscible liquids. In some embodiments, fluid 16 comprises a mixture of two or more immiscible liquids. In some embodiments, fluid 16 comprises one or more supercritical fluids. In some embodiments, fluid 16 comprises one or more dissolved salts. In some embodiments, fluid 16 comprises one or more buffering agents or pH adjusters. In some embodiments (as will be referenced in further detail below), fluid 16 comprises one or more catalysts or further reactants. It is to be understood that, during use, the composition of fluid 16 may change.

In some embodiments, fluid 16 is a liquid solution. In some embodiments, fluid 16 is a liquid dispersion (e.g., a sol). Where the fluid is a dispersion, the particles therein can be of varying particle sizes, e.g., from about 0.05 nm to about 1000 μm in diameter. The composition of particles that may be present within a dispersion of fluid 16 can be, e.g., the one or more catalysts, further reactants, or other compounds as described herein (e.g., where they are at least partially insoluble in the fluid 16 within the reservoir). In some embodiments, fluid 16 is an emulsion or suspension. In further embodiments, fluid 16 can comprise a mixture of one or more of particle suspensions, sols, miscible fluids, immiscible fluids, and supercritical fluids.

The amount of fluid 16 within reservoir 14 is not particularly limited, but is typically an amount sufficient to allow for direct contact between fluid 16 and at least one outlet 13′ associated with plasma device 12 (such that plasma released therefrom is released directly into the fluid). In some embodiments, the amount of fluid 16 is such that the plasma device 12 is completely submerged therein. Advantageously, at least outlet 13′ is completely submerged in fluid 16. Generally, the amount of fluid 16 may be such that there is at least some headspace 18 above the fluid within reservoir 14.

As such, reservoir 14, in some embodiments, further comprises some amount of headspace above the fluid 16, shown as 18 in FIGS. 1 and 2. The amount of headspace within the reservoir is not particularly limited; in some embodiments, the volume percentage of fluid 16 within reservoir 14 is greater than the volume percentage of headspace 18 within reservoir 14. However, the disclosed systems are not limited thereto. Headspace 18 generally comprises one or more components in gaseous form. In some embodiments, headspace 18 comprises compounds that are not substantially dissolvable in fluid 16. As desired, the gaseous component within headspace 18 can, in some embodiments, be removed from system 10 via outlet 19 (as batches or as a continuous stream). In some embodiments, this outlet is controlled via a valve or similar device to ensure the gaseous component is removed only when desired.

In some embodiments, system 10 can further comprise one or more catalysts and/or further reactants and/or other compounds. In some embodiments, the optional one or more catalysts, further reactants, or other compounds as described herein can be included in the fluid 16 of the reservoir. In some embodiments, the optional one or more catalysts, further reactants, or other compounds as described herein can be included in the headspace 18 of the reservoir. In some embodiments, the optional one or more catalysts, further reactants, or other compounds as described herein can be contained within plasma device 12. In some embodiments, the optional one or more catalysts, further reactants, or other compounds as described herein can be contained within a system output (e.g., fluid output 15′ as shown in FIGS. 1 and 2 or gas output 19 shown in FIGS. 1 and 2). For example, in some embodiments, an outlet can be adapted to contain a catalyst such that harmful or unwanted compounds produced within the system can be converted to other compounds before being removed from the system. In some embodiments, an outlet can be adapted to provide pH buffering or add other chemical species into a fluid prior to removal from the system. In some embodiments, the outlet is attached to a further unit/chamber that can achieve such purposes.

In some embodiments, one or more catalysts, further reactants, or other compounds can be contained within fluid 16 (e.g., dissolved or dispersed therein). In some embodiments, catalysts, further reactants, or other compounds that are typically immiscible with fluid 16 can be dispersed in the fluid using micellular structures to aid in bringing them into solution or suspension. In some embodiments, one or more catalysts, further reactants, or other compounds can be contained within a perforated container (e.g., component 21 of FIG. 2). In some embodiments, one or more catalysts, further reactants, or other compounds can be deposited onto a porous (e.g., nanoporous) substrate scaffold, which can be within fluid 16 (e.g., component 25 of FIG. 2, attached to reservoir 14 via support 26) or within headspace 18 (e.g., component 23 of FIG. 2). In FIG. 2, support 26 could act as an insulator such that 25 is electrically biased galvanically, due to the material that comprises 25 or by applying an external electrical bias (either DC or AC) through a wire through this support 26 (e.g., similar to the configuration depicted in FIG. 8, element 47). In some embodiments, one or more catalysts, further reactants, or other compounds are provided as a consumable component (e.g., block) of material (e.g., component 25 of FIG. 2) that can undergo chemical wear and attrition in the presence of the surrounding fluid 16. Additional stirring or agitation in the reservoir can, in some embodiments, be advantageous to promote fluid circulation, mixing, and/or shearing. In certain embodiments, such stirring or agitation can create a suspension, permanent suspension, or sol of catalyst and/or further reactant within the fluid. This stirring or agitation can be provided, e.g., by an impeller or other means (e.g., component 24 of FIG. 2).

It is to be understood that, where system 10 comprises one or more catalysts, further reactants, or other compounds as described herein, their location is not limited to those shown in FIG. 2. For example, a given system may comprise more than one scaffold (each having the same or different catalyst(s) and/or further reactant(s) and/or other compound(s) associated therewith), which can be adjacent to one another or in different areas of the reservoir.

The composition of the optional one or more catalysts, further reactants, or other compounds can vary widely and may be selected based on the desired chemical reaction to occur within fluid 16. In some embodiments, the one or more catalysts, further reactants, or other compounds as described herein comprise one or more salts (e.g., sodium chloride, potassium chloride, and the like). In some embodiments, the one or more catalysts, further reactants, or other compounds as described herein comprise one or more pH adjusters and/or buffers (e.g., acids, bases, and the like, including, but not limited to, calcium carbonate, calcium hydroxide, calcium nitrate, sodium carbonate, sodium hydroxide, sodium nitrate, ammonium nitrate, potassium carbonate, potassium hydroxide, potassium nitrate, nitric acid, nitrophosphates, lime, potash, sodium salts, rock phosphate, phosphoric acid, sulfuric acid, or any combination thereof). pH adjusters and/or buffers may, in some embodiments, modify/influence reaction products produced therein and/or enhance the efficiency of the chemical reaction(s)).

In some embodiments, the one or more catalysts, further reactants, or other compounds as described herein comprise one or more catalysts that may be advantageous in effecting the desired chemical conversion(s). Depending on the desired conversion, one of skill in the art will be aware of suitable catalysts that can be optionally included within system 10 in some embodiments. Examples of catalysts that can be employed in various embodiments include consumable and non-consumable catalysts. The composition of the catalyst(s) in a given system/method as provided herein will depend on the gaseous input and the desired chemical reaction occurring within the system. In some embodiments, the catalyst is a metal-containing reagent, e.g., a metal with d-subshell orbitals with holes/deficiencies therein. For example, metal-containing catalysts comprising copper, chromium, manganese, and/or iron may be advantageous in enhancing hydrazine decomposition and other transformations. In one embodiment, the metal-containing catalysts comprise noble metal surfaces (e.g., platinum, palladium, ruthenium, rhodium, silver, or gold). In one embodiment, the catalyst comprises platinum, palladium, tungsten, zirconium, hafnium, molybdenum, or aluminum. In one embodiment, the catalyst is manganese dioxide. In one embodiment, the one or more catalysts, further reactants, or other compounds comprise an oxidizing compound, e.g., including, but not limited to, peroxides or ozone. In another embodiment, one or more catalysts can be provided to convert excess hydrogen peroxide produced, e.g., when operating with an air input/water fluid to form water and oxygen catalyzed products.

In addition to or in combination with an inorganic catalyst or an appropriately selected natural or synthetic enzyme may be used to promote specific chemical reactions. An example of a non-aqueous fluid that could be used is anhydrous ammonia or alternatively liquid nitrogen or mixtures of other liquified gases that are available commercially (e.g., including oxygen, nitrogen, fluorine, chlorine, bromine, and combinations thereof), as well as organic and inorganic compounds, and polymeric materials. Alternatively, the fluid could be a molten metal such as, but not limited to, aluminum, gallium, or indium where a plasma working gas such as nitrogen or ammonia could be used to form AlN, GaN, InN as the activated atomic nitrogen plasma species interact with the molten metal. Other metals may also be used especially when it is desirous to produce micron sized, nano sized, or quantum confined compounds. Eutectic or near-eutectic mixtures of some metals may provide lower temperature operating conditions such as the use of indium-gallium-tin alloys which are liquid at temperatures as low as −19° C. or sodium potassium alloys “NaK” which also exhibit a wide liquidus range. In some embodiments, fluid 16 comprises one or more further reactants, e.g., consumable reactants that can react with plasma-generated chemical species that are produced within plasma device 12 and then injected into reservoir 14. In one embodiment, the one or more reactants comprise calcium carbonate or another basic salt such as sodium carbonate, sodium bicarbonate, or potassium carbonate, or essentially any soluble material that has a high pH coupled with a plasma produced low pH material that results in secondary or tertiary chemical reactions to occur in the fluid reservoir. Conversely the fluid medium could be comprised of a low pH material which interacts with a plasma produced effluent that is high pH resulting in a chemical reaction between the constituents.

In some embodiments, the system is equipped with further components. A more specific example system 10 is depicted in FIG. 2, which includes (in addition to the general components outlined herein above with respect to FIG. 1), a number of further components that can be included within the system in any combination. It is to be understood that, although these components are all shown within the example system shown in FIG. 2, they may individually be employed in system 10 in various embodiments or employed in any combination of two or more such components.

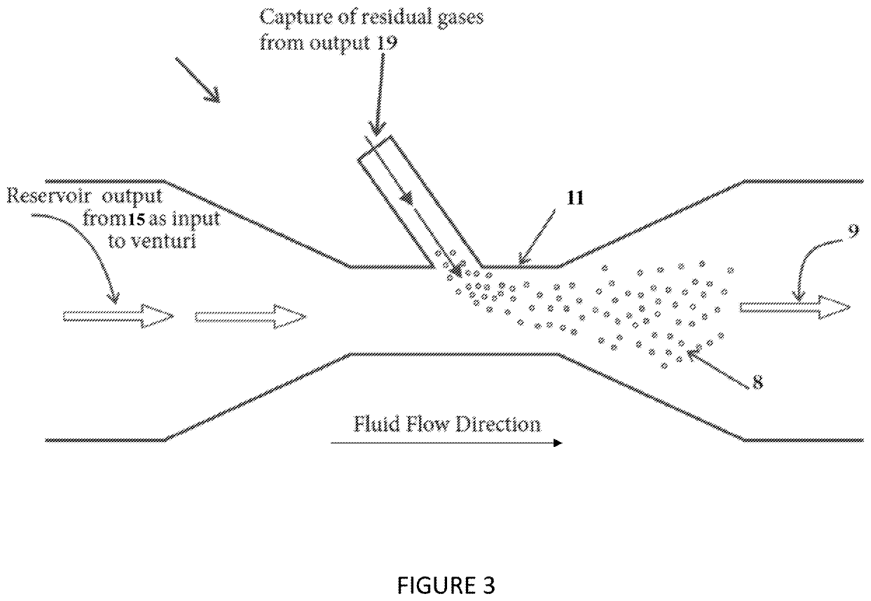

In some embodiments, the system comprises a component for recycling gases in headspace 18 of the reservoir, e.g., which were previously contained within and/or generated within fluid 16 that may be of interest. For example, gases that are not captured by the initial plasma-liquid-gas contact can be collected from port 19 and recycled/reintroduced to fluid 16 and/or into plasma device 12. Such a component can comprise, e.g., one or a series of pipes/tubes, injection via venturi, cavitation tube, nano-bubbling device, or the like to promote mixing and solvation of the gases into fluid 16, or any combination of two or more such components. A venturi is shown in FIG. 3, wherein cavitation occurs after the venturi throat 11 due to the rapid depressurization of the mixture, enhancing the mixing of smaller bubbles 8. The final product 9 is a liquid that contains the solvated chemical species produced in the plasma and now present in a liquid/fluid output for either direct use or further processing (e.g., to add to any additional chemical species required for a given application).

In addition, further components may be incorporated within such systems without departing from the present disclosure. It is to be understood that conduits, valves, (e.g., one-way valves and variable flow valves), other pressure and flow regulating devices, ports, storage units, filters, pumps, compressors, blowers, energy sources, and the like can be included within systems where appropriate without departing from the invention. In some embodiments, an electrical bias can be applied to reservoir 14 and/or an internal electrode placed in proximity to plasma device outlet 13′. Such bias can, in some embodiments, be used to influence the flow of ionized chemical species and/or promote additional secondary chemical reactions in the volume of the reservoir and/or on the surface of the electrodes or the reservoir wall(s).

In some embodiments, a system comprises a plurality of plasma generators, each of which can be configured to receive an independent gas input stream (allowing for the introduction of two or more plasmas with different compositions into reservoir 14 (at the same or different times). In some embodiments, a system comprises a plurality (two or more) plasma generators that are in parallel or in series. It is to be understood that suitable inlets/outlets and conduits will be provided in such embodiments to accommodate the operation of the system 10 according to the principles outlined herein. Furthermore, the disclosure contemplates combinations of multiple systems, e.g., each with distinct chemical input (and corresponding distinct outputs), which can be combined to make new desired mixtures of products.

The present disclosure provides, in addition to the disclosed systems, various methods associated with the use of the disclosed systems. The disclosure provides, in some embodiments, methods for effecting certain chemical reactions using the disclosed systems. Such chemical transformations can be effected, e.g., via the direct injection of plasma (including plasma-generated chemical species) into fluid 16. In some embodiments, the direct injection of the plasma results in a localized region of high energy (e.g., high temperature and high pressure) around the site of contact between the plasma and fluid 16 that may, in some embodiments, be favorable for efficient chemical reactions. Such chemical reactions can, in some embodiments, be faster than in other methods of effecting such chemical reactions. Such systems and methods can, in some embodiments, allow for chemical reactions to be effectively conducted which would normally require industrial scale chemical facilities and/or complex, high power, high temperature, high pressure chemical reactors. The systems and methods can further, in some embodiments, employ chemical feedstocks that are lower cost and pose less potential to be damaging to the environment than such industrial scale processes.

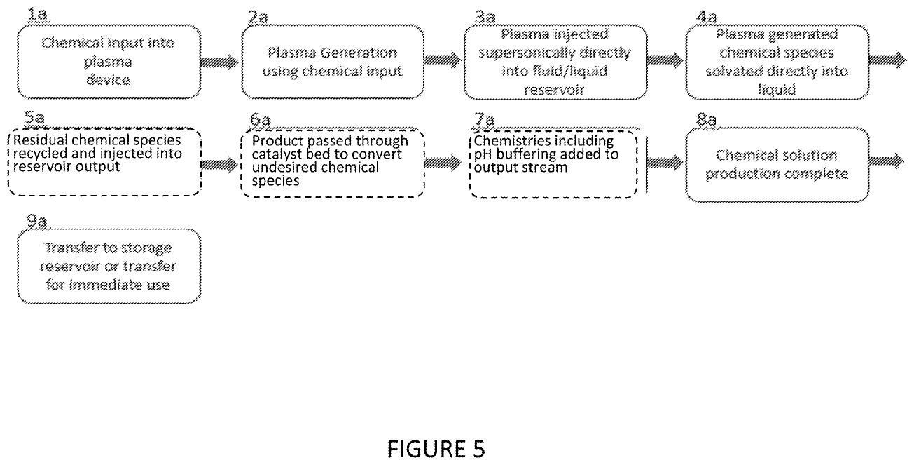

Generally, a non-limiting method for effecting a chemical reaction as provided herein can, in some embodiments, comprise the following steps: A) providing a chemical input into plasma device 12, B) generating a plasma (comprising plasma-generated chemical species) within the plasma device, and C) injecting the plasma directly into fluid 16 within reservoir 14. The method can include various additional steps before, after, or between various steps, as will be outlined herein below. This method advantageously is an efficient means to introduce plasma-generated chemical species directly into a fluid, which can result in further chemical reaction(s) within the fluid. In some embodiments, the method is suitable for producing a chemical mixture or precursor mixture to create an on-demand chemical product. One non-limiting specific method for effecting a chemical reaction is depicted in FIG. 5 (wherein steps shown within dotted lines are understood to be optional). In FIG. 5, Step C) referenced above (encompassing depicted steps 1a, 2a, and 3a) results in plasma-generated chemical species becoming solvated within fluid 16 (4a). The residual chemical species can optionally be recycled and injected into the reservoir output (5a). This residual chemical species includes, e.g., any non-solvated chemical species (which may result for various reasons, e.g., localized saturation or undesirable reaction of the chemical species, rendering it less soluble).

The liquid product stream is removed and can optionally be passed through a catalyst bed to convert undesired chemical species (6a), followed by the optional addition of any desired reagents (e.g., for pH buffering or addition of other chemistries to the output stream) (7a) before the production is considered to be complete (8a). The resulting treated stream is then transferred to a storage reservoir or for immediate use (9a).

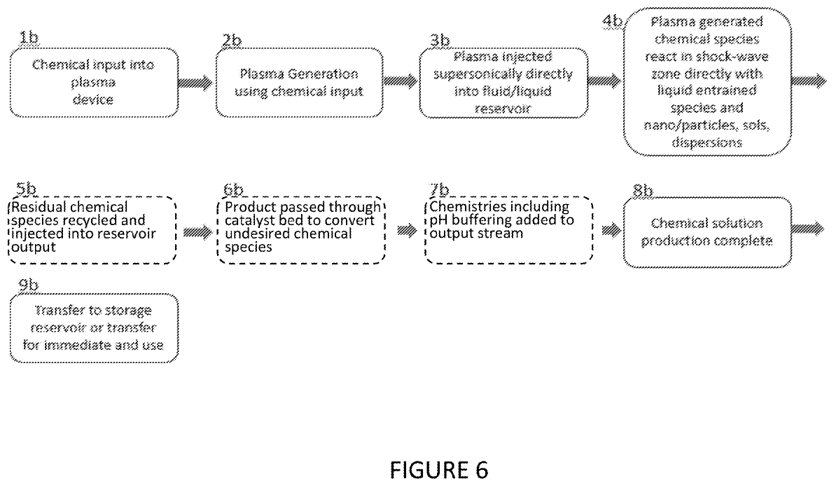

Another non-limiting specific method for effecting a chemical reaction is depicted in FIG. 6, wherein step C) referenced above (encompassing depicted steps 1b, 2b, and 3b) results in plasma-generated chemical species reacting in the shockwave zone with liquid-entrained species, nanoparticles, sols, dispersions, etc. (4b). As in the embodiment of FIG. 5 referenced above, the residual chemical species can optionally be recycled and injected into the reservoir output (5b). Optionally, a process/conversion can be performed on the residual chemical species prior to this recycling/injection to alter it before the recycling/injection (not shown). As one specific embodiment, in the case of NOx, the NO2 is readily absorbed in water but, as NO has low solubility in water, any NO in the residual chemical species is advantageously treated (i.e., oxidized) so as to convert as much NO as possible to NO2 to ensure adsorption in the water. This conversion can be done, e.g., via a secondary plasma process where additional air or oxygen-containing gas is mixed into the residual chemical species stream and allowed to react. Such a process may require a substantially long tube or auxiliary reservoir (not shown in the depicted systems) to provide sufficient time/space for the NO oxidation to occur. In other embodiments, oxidation of NO to NO2 is promoted using suitable catalysts or by just allowing sufficient residence time in process tubing to allow for sufficient oxidation.

The liquid product stream can then optionally be removed and passed through a catalyst bed to convert undesired chemical species (6a), followed by the optional addition of any desired reagents (e.g., for pH buffering or addition of other chemistries to the output stream) (7b) before the production is considered to be complete (8b). The resulting treated stream is then transferred to a storage reservoir or for immediate use (9b).

Step A comprises providing a chemical input into plasma device 12. The chemical input is typically in gaseous form and can vary based on the desired product. Non-limiting examples of chemical inputs that can be utilized in various embodiments include air (˜78% N₂, ˜21% O₂), methane, ethane, alkanes, phosphane and other phosphorous-containing gases, nitrogen-containing gases (e.g., ammonia, hydrazine, dimethyl hydrazine), hydride gases, elemental gases, including, but not limited to, hydrogen (H), nitrogen (N), oxygen (O), fluorine (F), chlorine (Cl), helium (He), neon (Ne), argon (Ar), krypton (Kr), Xenon (Xe), and any combination of two or more thereof.

Step B comprises generating a plasma within the plasma device. The specific method by which the plasma is generated can depend, for example, on the type of plasma device 12 employed and one of skill in the art is aware of suitable means for producing a plasma from a given chemical input based on the method of operation of the given type of plasma device. For example, certain plasma devices operate by applying voltage across two or more electrodes contained within the plasma device. Certain plasma devices operate by applying heat to the chemical input to the plasma device.

Generally, during operation of a plasma device, ionization of the chemical input occurs, creating atomic species, ionized species, electrons, metastables, and/or molecular fragments (referred to herein as the “mixture” comprising “plasma-generated chemical species”). In some embodiments, inside the plasma device may be a stabilized vortex flow of shield gas that envelopes the internal plasma phase column to enhance reactive species generation and minimize plasma neutralization inside the plasma device.

Step C comprises injecting the plasma directly into fluid 16 within reservoir 14. By “directly into fluid 16” is meant that the plasma is produced and injected into the fluid within a sufficient time/distance range so as to result in electrical current flow from the active plasma exiting the device (e.g., through a nozzle) with current flowing through the plasma into the fluid that it is in intimate contact with. There may also be situations where the electrical current flows only through the plasma and does not penetrate into the surrounding fluid due to the insulating nature of the fluid or because the electrical bias placed on the plasma device is such that the return current path through the plasma device is a lower impedance than through the surrounding medium. In some embodiments, the area of excitation is directly adjacent to the point of injection with the distance being essentially on the order of the atomic distances between the material comprising the plasma medium and the material comprising the fluid medium. The presence of bubbles or other regions of inhomogeneous material could effectively extend this interface to within a few millimeters of the point of injection (i.e., where the plasma contacts the fluid). In some embodiments, the time period between the plasma exiting the area of excitation to the plasma contacting the fluid is minimal and approximately equal to the time required to traverse the thickness of the local boundary layer between the nozzle surface and the exit orifice; it is understood that the velocity of the plasma travel (and thus the time period between the plasma exiting the area of excitation and the plasma contacting the fluid) can be impacted by various parameters, e.g., viscosity, local temperature and pressure conditions. The velocity of plasma exiting the plasma device can, in some embodiments, approach or exceed supersonic speeds at the local temperature, pressure and composition of material that is supported by the local medium or fluid. A broad range, for water as an example could be between 1400 m/s to 1600 m/s. This value, as would be appreciated by one of skill in the art is necessarily dependent on a number of parameters (e.g., the specific medium/fluid, temperature, pressure, etc.) Generally, within the plasma device 12, the plasma is initiated in a subsonic flow region, It is then passed through a converging-diverging nozzle or other means to accelerate the plasma from subsonic to supersonic speeds while retaining sufficient plasma electrical conductivity in the plasma to allow the exiting supersonic plasma flowing out of the plasma device to maintain or extend the flow of electrical current through the plasma and hence maintain the active plasma formation region all the way to the interface of the surrounding fluid and in some embodiments causing additional ionization of the fluid medium. In the case where the fluid medium is also ionized there is a highly variable area of mixing between the plasma and surrounding fluid interface. In another embodiment both the plasma output and the fluid medium have sufficient electrical conductivity such that a constant current flows from the plasma and into the fluid medium completing an electric circuit between the interface of the plasma and the fluid medium. The electrical circuit may be maintained by either a AC or DC bias at a sufficient voltage to maintain current flow across the interface. Highly conductive fluids, such as metals, or highly saturated salt solutions may require voltages on the order of 2V to 50V to maintain current flow. Other materials, such as high purity distilled or deionized water, would require much larger voltage on the order of 50-100 kV to maintain ionization channel through the normally nonconductive fluid.

Typically no conduit/pipe/tube is provided between outlet 13′ of the plasma device 12 and the fluid 16. As such, in some embodiments, the nozzle is in direct/intimate contact with the fluid. This configuration can uniquely take advantage of the direct delivery of plasma into fluid 16, e.g., with high velocity, providing benefits such as enhanced reaction rates, enhanced conversion percentage, and the like. Advantageously, the gases used to generate the plasma discharge within plasma device 12 are used to deliver the plasma (containing the plasma-generated chemical species) directly into fluid 16.

The mixture within plasma device 12 (including gases and the plasma-generated chemical species) is generally forced through outlet 13′ so as to create flow as the mixture passes therethrough and into reservoir 14. The flow can be generated, e.g., via a converging/diverging nozzle, orifice plate, or any fluidic structure associated with outlet 13′.

The exit velocity from plasma device 12 can be varied, e.g., such that the mixture of components from the plasma device is injected into fluid 16 at different sub-sonic, sonic, or super-sonic plasma exit velocities. In a non-limiting example, the mixture of components (including the plasma-generated chemical species generated within the plasma device) is accelerated to supersonic velocities as it exits the device (e.g., through a converging-diverging nozzle). This acceleration creates a shock front as the supersonic flow of the mixture encounters the slower moving fluid 16 within reservoir 14. The shock front is, in some embodiments, equivalent to the shock front that is produced as a detonation wave passes through a mixture (as the nozzle acts as a stationary or standing detonation wave that remains in place as the mixture passes through the stationary detonation wave). At and around the interface of plasma, gas, and liquid phases within reservoir 14, various processes can occur, including, but not limited to, plasma-fluid interactions, cavitation, shockwaves, energy exchange collisions, solvation, diffusion, and the like, which can aid in the transfer of the plasma-generated chemical species directly into the fluid. In some embodiments, energy transfer to the fluid 16 can promote solvation of plasma-generated chemical species, allowing them to interact efficiently with fluid 16 and any reagents (e.g., catalysts, etc.) present therein.

Although not intending to be limited by theory, it is believed that the introduction of the mixture in this manner creates a high-energy (“shock”) region that is particularly advantageous for reaction between plasma-generated chemical species and fluid 16 (or catalysts, reagents, etc. present therein). The turbulent and shocked flow caused by the plasma flowing out of outlet 13′ and into fluid 16 in this manner induces shockwaves and cavitation at the boundary between the fluid and plasma phase. Shockwaves are produced here, due to the reduction in the speed of sound in the mixture of gas and fluid, where the energy is used to produce additional chemical species of interest because of localized increases in pressure, density, and temperature at the interface of the shockwave front.

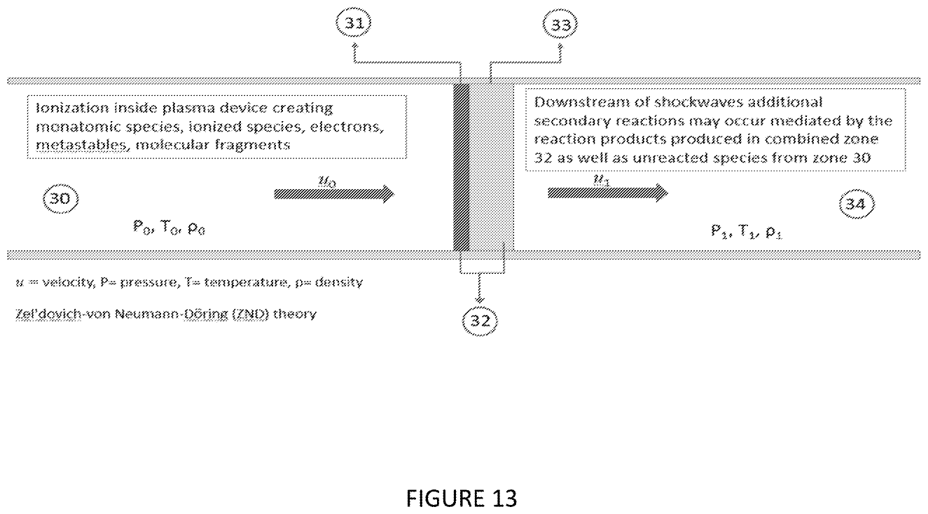

This phenomenon is typically understood based on Zel'dovich-von Neumann-Döring (ZND) detonation/shockwave theory. This theory predicts that the detonation wave compresses the chemical species present in the gas-plasma mixture by the shock front leading to high temperatures and pressures (called the von Neumann spike or the ZND point). See 30 of FIG. 13. This is followed, in some embodiments, by finite rate chemical reactions (“secondary reactions”) that occur behind the shock front in the downstream reaction zone (31 of FIG. 13). The high temperature and pressures at the shock front are utilized to rapidly create high temperatures and pressures that, in some embodiments, are favorable for efficient chemical reaction. The energy released may be utilized for mixing the fluid with the product-rich plasma as well as heating the fluid. As new chemical species are formed in the shock region, they may be then rapidly transported into the ambient environment elsewhere within reservoir 14, where they can, in some embodiments, be quenched by the direct interaction and injection into fluid 16 (e.g., at a temperature less than 373K, which can in some embodiments prevent a reverse reaction back to reactant(s)). Remaining gases that do not dissolve in fluid 16 can, in some embodiments, float to the surface of the fluid and accumulate in headspace 18 within the reservoir 14.

In some embodiments, the fluid 16 within the reservoir following Step C (comprising the desired reaction product(s)) can be withdrawn (e.g., pumped) from the system (e.g., through output 15′) and directly used. In some embodiments, the fluid 16 is withdrawn and further treated/processed prior to use. For example, the fluid can be pH-adjusted (via addition of acidic or basic reagents), concentrated, diluted, filtered/centrifuged, extracted, further reacted, dried, and/or the like. In some embodiments, the fluid 16 following Step C is pumped into a separate reservoir. In some embodiments, the fluid is pumped into an additional gas injection stage to utilize remaining soluble chemical species collected from the output 15′. A nano-bubbler, static mixer, air-stone, venturi, or other device used to introduce gas species into a fluid can be used to introduce the remaining chemical species into the fluid.

In some embodiments, gases within headspace 18 following Step C (comprising, e.g., waste gases and/or gases of interest) are withdrawn from the system. As described in detail above, the system may be equipped with one or more components that direct at least some such gases back into the system. In other embodiments, the gases can be removed from the system to be treated, disposed of, or stored. In some embodiments, the gases are reintroduced into the inlet/gas feed port (13) of the plasma device and/or downstream into another mixing port, and/or can be injected back into the fluid 16 (e.g., using a venturi, cavitation plate/tube, nanobubbler device, or a gas absorption/scrubbing tower).

In some embodiments, the system 12 can be subjected to centrifugal separation following Step C (e.g., where the gas is mixed with the fluid 16 or where the system is operated under conditions of reduced or no gravity), followed by removal of gases and/or fluids from system 12.

In some embodiments, the method can further comprise monitoring the reaction within reservoir 14. For example, it may be advantageous to monitor the reaction to measure the amount of desired (or undesired) product present within fluid 16 at various time points after introduction of the plasma. As such, the system can employ on or more sensors or other means for monitoring the chemical conversion process within reservoir 14. In some embodiments, the system comprises one or more toroidal conductivity sensors, dynamic light scattering sensors, viscometers, temperature sensors, pressure sensors, molecular weight sensors, refractometers, optical fiber sensors, and the like. Monitoring the reaction can be accomplished in various ways, e.g., via spectroscopy. One non-limiting method for monitoring the reaction is laser-induced fluorescence (LIF), e.g., useful to measure NO present within the reservoir. Other examples of monitoring methods include, but are not limited to, FTIR spectroscopy, Raman spectroscopy, thermal monitoring, Electrical Impedance Spectroscopy, Optical emission spectroscopy, optical absorption, pH, ion selective membrane sensors, x-ray diffraction, x-ray scattering, Zeta potential monitoring, pressure, piezoelectric sound and vibration sensors, viscometers, refractometers, DSC, Magnetic sensors, rheological meters, surface acoustic mapping, acoustic imaging/tomography, and high-resolution ultrasound imaging.

In further embodiments, the method can further comprise introducing electromagnetic radiation (e.g., x-ray, ultraviolet, visible, infrared, and/or microwave radiation) into the system. This introduction can be achieved, e.g., via a window in reservoir 14. For example, the method can comprise introducing a specific wavelength of light or a range of wavelengths of light into the reservoir. The introduction of energy in this way can, in some embodiments, provide additional activation energy to the chemical mixtures in the reservoir and/or provide energy to excite secondary chemical reactions on photocatalytic surfaces within the reservoir. In some embodiments, the method can comprise introducing microwave or radiofrequency energy into the system, e.g., to heat the fluid within the chamber and/or to selectively couple the energy into structures (e.g., such as engineered arrays of resonant antenna structures) to provide conversion of the energy into electrical signal. This electrical signal output, in some embodiments, can be used to power devices associated with system 10. The electrical signal output, in some embodiments, can be used to drive one or more additional electrochemical processes inside the reservoir (producing, in various embodiments, secondary, tertiary, or other desired chemical species).

Generally, the disclosed method can be modified by varying a range of parameters associated with system 10. Such parameters and examples of suitable ranges of operation are provided herein below. One of skill in the art will be able to suitably adjust such parameters to achieve the desired output.

For example, various pressures can be employed inside and outside of system 10. The system can be operated using various pressures within reservoir 14, e.g., 1×10⁻⁵ Torr to 100 Bar, such as 0.1 Bar to 20 Bar and 0.5 Bar to 5 Bar. The system can be operated using various pressures outside the reservoir, e.g., 1×10⁻⁵ Torr to 100 Bar, such as 0.1 Bar to 20 Bar and 0.5 to 5 Bar. The system can be operated at various pressures in plasma device 12, e.g., 1×10⁻⁵ Torr to 100 Bar, such as 0.1 Bar to 20 Bar and 0.5 to 5 Bar.

As another example, various temperatures can be employed inside and outside of system 10. The system can be operated using various temperatures within reservoir 14 and various temperatures of fluid 16, e.g., 0K to 3000K. The system can be operated using various temperatures outside the reservoir, e.g., 0K to 3000K. The system can be operated at various temperatures in plasma device 12, e.g., 0K to 3000K. Further, the plasma injected from the device into fluid 16 can be provided at various temperatures, e.g., 0K to 3000K. Although the method and system provided herein can be operated within such ranges, in some embodiments, to minimize the amount of energy employed, it may be advantageous to operate the method and system at or near ambient/temperature pressure conditions.

As another example, plasma device 12 can be operated under various conditions. Plasma device 12 can be operated at voltages ranging, e.g., from 0.1 volts to 100,000 volts, e.g., 300 volts to 20,000 volts. Plasma device 12 can be operated at amperages ranging, e.g., from 0.1 A to 100,000 A, such as from 1 A to 500 A. Plasma device 12 can be operated to produce a variety of electron temperatures, e.g., ranging from 0.1 eV to 1000 eV, such as from 0.5 eV to 10 eV.

As a further example, gas flow rates (e.g., continuous flow into and/or out of reservoir 14) can be varied, e.g., from 0.01 SLM to 100,000 SLM, e.g., from 1 SLM to 1000 SLM. Reservoir fluid flow rates (e.g., continuous flow into and/or out of reservoir 14 can also be varied, e.g., from 0.01 SLM to 100,000 SLM, e.g., from 1 SLM to 1000 SLM. It is to be understood that the gas flow rates and the fluid flow rates may vary from one another; in some embodiments, the gas flow rate may be greater than the fluid flow rate and in other embodiments, the fluid flow rate may be greater than the gas flow rate. In further embodiments, the gas flow rate and fluid flow rate may be substantially the same. During operation of the system according to the methods provided herein, the gas flow rate and/or the fluid flow rate may be substantially constant or can be varied over time.

The reactions that can be conducted via the disclosed method (and within the disclosed system) can vary widely and, as referenced above, can be varied based, e.g., on the input gas (or gases) into plasma device 12 and/or the composition of fluid 16 (as well as any catalysts, further reactants, etc. present within the system).

In one embodiment, the method comprises employing nitrogen as an input gas to plasma device 12, employing a fluid 16 comprising water, and operating system 10 under anaerobic conditions to produce a product comprising ammonia. In one embodiment, the method comprises employing air as an input gas to plasma device 12, employing a fluid 16 comprising water, and operating system 10 under aerobic conditions to produce a product comprising nitric acid. In a further embodiment, both methods referenced in this paragraph can be conducted, e.g., in series or simultaneously in different systems; in some embodiments, the products of these two systems can be combined to form an ammonium nitrate solution in water.

One specific, non-limiting method for effecting a chemical reaction to produce a nitric acid-containing product according to the systems and methods provided herein is in the context of producing nitric acid, as follows. Step A comprises providing air as the input to a plasma device (e.g., a non-thermal plasma device). A plasma is generated in the device (Step B). For example, high energy electrons within the device can collide with nitrogen and oxygen molecules, dissociating them into monoatomic nitrogen and oxygen and vibrationally exciting them, leading to Zel'dovich-like reactions to form nitrogen oxides at ambient pressures and non-thermal plasma temperatures. As such, the plasma can comprise, e.g., N₂, O₂, N, O, OH, and H radicals, as well as nitrogen oxide (NOx) compounds (e.g., NO). In step C, the plasma is injected into a water-containing fluid within the reservoir, maintained, e.g., at a temperature of approximately room temperature (293K). The direct injection of the plasma the water-containing fluid provides a rapid quenching that locks in the NO created in the plasma device and the shock-front created by the converging diverging nozzle or orifice plate further enhances formation of NOx species according to the aforementioned ZND mechanisms. It should also be noted that the use of a non-thermal plasma discharge allows non-equilibrium production of monatomic nitrogen and oxygen as well as vibrationally excited molecules and radicals which can provide alternative chemical routes to produce NOx or other gaseous species of interest at enhanced efficiencies. Higher instantaneous temperatures and pressures occurring in the outflowing shockwave zone in the plasma can lead to more efficient production of the desired products (e.g., higher NOx production efficiencies) coupled with a rapid quenching of the high temperature and pressure region downstream of the shock zone to prevent thermal degradation of the as-produced products (e.g., NOx). The plasma developed in this system allows for a significant NOx production in the plasma channel prior to solvation in water. The direct conversion of air to directly and/or indirectly form a range of chemical species (e.g., including, but not limited to, nitrogen oxides) using a plasma in this manner can eliminate the need for higher temperatures and pressures, such as those required by the Haber Bosch process. Extended Zeldovich mechanisms occurring in certain such embodiments are as follows:

$$O + {N}_{2} ⇆ NO + N , {k}_{f} = 2 \times {10}^{14} exp ( - 315 / RT ) , {E}_{A} = 315 kJ / mol$$

$$N + {O}_{2} ⇆ NO + O , {k}_{f} = 6.4 \times {10}^{9} exp ( - 26 / RT ) , {E}_{A} = 26 kJ / mol$$

$$N + OH ⇆ NO + H , {k}_{f} = 3.8 \times {10}^{13}$$

A non-limiting list of other chemical reactions possible for NOx production (with reaction rates and activation energies where available) is as follows:

$${N}_{2} + H ⇆ NNH , 1 E 09$$

$$NNH + O ⇆ NO + NH , 5.2 E 11 , - 490 cal , - 1.7 kJ / mol$$

$$NO + H {O}_{2} ⇆ {NO}_{2} + OH , 2.1 \times 1012 , - 497 cal , - 2.1 kJ / mol ( fast reaction ) {HO}_{2} = hydroperoxy radical$$

$${NO}_{2} + O ⇆ NO + {O}_{2}$$

$${N}_{2} O + O ⇆ NO + NO , 3.2 E 12 , 27679 cal = 115.8 kJ / mol$$

$$NNH + NO ⇆ {N}_{2} + HNO , 5. \times 1013$$

$$HNO + OH ⇆ {H}_{2} O + N O , 3.6 \times 1013$$

$$HNO + {O}_{2} ⇆ {HO}_{2} + N O , 16000 cal = 66.9 kJ / mol$$

$$OH + {H}_{2} {O}_{2} ⇆ {H}_{2} O + H {O}_{2} ( production pathway for hydroperoxyl radical )$$

$$NH + {O}_{2} = N O + OH , 1.3 E 6 , 100 cal , 0.418 kJ / mol$$

The applications of the disclosed systems and methods are wide ranging. Advantageously, a system/method as provided herein can, in some embodiments, be used to create an on-demand chemical product. As such, the system/method provided herein can, in some embodiments, enable localized production. In some embodiments, the system/method provided herein can be powered by a source other than fossil fuels, e.g., via green or renewable sources. In some embodiments, the system/method provided herein operates using electricity.

In the example referenced above (involving production of a nitric acid-containing fluid within system 10), the product can be used, e.g., as a liquid fertilizer precursor. The nitric acid-containing fluid can be used, e.g., as a ready-to-use product capable of being applied directly to crops planted in soil. The nitric acid-containing fluid can be treated to adjust the pH thereof and then applied hydroponically. In certain embodiments, the disclosed system can be used as a point-of-use system to decentralize fertilizer production, which can provide, e.g., for locally produced, on-site production of fertilizer only when needed. Such a point-of-use system and method can allow for increases in nitrogen use efficiency (NUE) that can limit the drawbacks of applying excess nitrogen fertilizer to crops (e.g., leaching, soil poisoning, and excess run-off leading to algal blooms, etc.). Further, such a point-of-use system and method can eliminate the need for transport of nitrogen fertilizers (which can be particularly relevant with transport to rural areas) and can eliminate/minimize costs associated with fossil fuel use, carbon emissions, and other things which add to the overall cost of conventionally produced fertilizers.

It is noted that the example system and method provided herein (providing a nitric acid-containing fluid) can have further applications other than in the agricultural field. For example, the nitric acid-containing fluid can again be neutralized (e.g., with ammonia) to produce ammonium nitrate; this ammonium nitrate can be employed, e.g., as an explosive for quarrying and mining. Advantageously, by producing ammonium nitrate using the disclosed point-of-use system, storage of excess ammonium nitrate can be avoided, and a sufficient amount can simply be produced on an as-needed basis (and then formulated, e.g., via mixture with oil and other fuels) at or nearby to the quarry/mine.

Although the application focuses on the production/use of nitric acid-containing fluids, it is to be emphasized that the disclosure is not limited thereto. The systems and methods disclosed herein can be used to effect a wide variety of chemical reactions for a wide variety of applications. Many modifications and other embodiments of the disclosed systems and methods will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for effecting a chemical conversion, comprising:
a plasma generating device comprising a gas input for a gas feed stream and configured for the production of a plasma output;
a reservoir having a fluid contained therein, and
an outlet component for direct delivery of the plasma output to the fluid in a manner sufficient to create supersonic flow within the fluid,
wherein the component for direct delivery of the plasma output to the fluid is submerged within the fluid.

2. The system of claim 1, wherein the outlet component for direct delivery of the plasma output to the fluid is selected from the group consisting of a converging/diverging nozzle and an orifice plate.

3. The system of claim 1, wherein the plasma generating device is submerged within the fluid.

4. The system of claim 1, wherein the plasma generating device is selected from a high frequency plasma generating device (e.g., induction plasma, capacitive plasma, torch plasma, corona discharge plasma, plasma with high-frequency corona, and microwave plasmas), an arc plasma generating device (e.g., a hollow cathode plasma), a magnetron source plasma generating device, a microwave plasma source, a cathodic arc source, an end hall source, an electron cyclotron source, a varying frequency capacitive source, a varying frequency inductive source, a transformer-type inductive plasmatron source, a dielectric barrier discharge source, and a capillary discharge source.

5. The system of claim 1, wherein the plasma generating device is a non-thermal plasma source that generates plasma via direct current (DC), alternating current (AC), radiofrequency (Rf) inductively coupled plasma (IC P), microwave, asymmetric unipolar or bipolar waveforms.

6. The system of claim 1, wherein the plasma generating device comprises one or more glow discharge electrodes, one or more dielectric barrier discharge electrodes, one or more thermally arcing electrodes, and/or one or more gliding arc discharge electrodes.

7. The system of claim 1, wherein the fluid comprises water.

8. The system of claim 1, wherein the fluid comprises a non-aqueous liquid.

9. The system of claim 1, wherein the fluid comprises one or more additives selected from catalysts, reagents, pH adjusters, buffers, and combinations thereof.

10. The system of claim 9, wherein the one or more additives are dissolved in or dispersed in the fluid.

11. The system of claim 9, wherein the one or more additives are in the form of a material contained within a porous container, a material deposited onto a substrate scaffold, or a consumable solid piece of material.

12. The system of claim 1, wherein the reservoir is open to atmospheric conditions.

13. The system of claim 1, wherein the reservoir is not open to atmospheric conditions.

14. The system of claim 1, further comprising a gas outlet to remove gas present or produced within the reservoir.

15. The system of claim 14, further comprising a conduit for directing the gas present or produced within the reservoir back into the plasma generating device or back into the fluid.

16. A method for effecting a chemical conversion, comprising:
introducing a gas feed stream into a plasma generating device;
operating the plasma generating device to produce a plasma output; and
injecting the plasma output through an outlet component into a reservoir having a fluid contained therein in a manner sufficient to create supersonic flow within the fluid,
wherein the outlet component is submerged within the fluid.

17. The method of claim 16, wherein the outlet component is selected from the group consisting of a converging/diverging nozzle and an orifice plate.

18. The method of claim 16, wherein the gas feed stream comprises air.

19. The method of claim 16, wherein the gas feed stream comprises methane, ethane, phosphane, ammonia, hydrazine, dimethyl hydrazine, hydride gases, hydrogen (H), nitrogen (N), oxygen (O), fluorine (F), chlorine (C), helium (He), neon (Ne), argon (Ar), krypton (Kr), Xenon (Xe), or any combination of two or more thereof.

20. The method of claim 16, wherein the plasma output is a non-thermal plasma.

21. The method of claim 16, wherein the fluid comprises water.

22. The method of claim 16, further comprising withdrawing a liquid product stream from the reservoir.

23. The method of claim 16, further comprising contacting the liquid product stream with one or more catalysts and/or pH adjusters.

24. The method of claim 22, wherein the gas feed stream comprises air, the fluid comprises water, and the liquid product stream comprises nitric acid.

25. A method of providing a point-of-use fertilizer composition, comprising:
introducing a gas feed stream comprising air into a plasma generating device;
operating the plasma generating device to produce a plasma output comprising NOx compounds; injecting the plasma output through an outlet component into a reservoir having a fluid contained therein in a manner sufficient to create supersonic flow within the fluid,
wherein the outlet component is submerged within the fluid and wherein the fluid comprises water;
withdrawing a liquid product stream from the reservoir; and
optionally adjusting the pH of the liquid product stream for use as a point-of-use fertilizer composition.
